(19) United States
(12) Patent Application Publication
(10) Pub. No.: US 2009/0090836 A1
(43) Pub. Date: Apr. 9, 2009

(54) Post Positioning Jig Assembly

(76) Inventor: Robert E. Harris, Columbia, SC (US)

Correspondence Address: TURNER PADGET GRAHAM & LANEY, P.A., P.O. BOX 1509, GREENVILLE, SC, 29602, US

(21) Appl. No.: 11/868,623

(22) Filed: Oct. 8, 2007

(51) Int. Cl. F16M 13/00

(52) U.S. Cl. 248/530; 248/545

(57) ABSTRACT

A post positioning device includes a collar defining a post positioning aperture therein for receiving a post; a stabilizer for removably securing the collar about the post; and a positioning system operably connected to the collar having a first angular state and a second angular state relative to the collar; wherein the positioning system is configured to adjust from the first angular state into contact with the post to maintain the post plumb in a hole in the second angular state.

### BACKGROUND OF THE DISCLOSURE

When setting vertical posts, such as deck posts, fence posts, goal posts, mailbox posts, sign posts and the like in a post hole, care must be taken to ensure that the post is plumb, i.e., level before filling the post hole with concrete or other filler. This task typically requires at least two workers—one to hold the post in position and hold a level while the other worker secures the post with at least two wooden braces. Care must be taken to ensure that the post remains plumb while the wooden braces are attached to the post with nails using a hammer, which ironically tends to move the post out of the plumb position. The post must also remain secured in the plumb position by the temporary braces, which are tripping hazards to the extent that the braces project from the post, while the concrete is poured into the hole and until the concrete cures. Accordingly, additional labor, time and expense are required to use conventional bracing methods.

What is needed in the industry is a compact, cost-effective system that can be employed by one person to set and plumb a post, and secure it in the plumb position while concrete is poured into the hole and while the concrete cures.

### BRIEF SUMMARY OF THE DISCLOSURE

The present disclosure is directed in general to post positioning jig assemblies that are compact and reusable. The various embodiments and their equivalents are used to set, plumb and hold posts in position within post holes while concrete, dirt and/or other filler is poured into the post holes around the posts. A single worker can efficiently set and secure posts with minimal effort using post positioning assemblies of the present disclosure and their equivalents.

According to a particular aspect of the disclosure, a post positioning device may include a collar defining a post positioning aperture therein for receiving a post; a stabilizer for removably securing the collar about the post; a positioning system operably connected to the collar having a first angular state and a second angular state relative to the collar; and wherein the positioning system is configured to adjust from the first angular state into contact with the post to maintain the post plumb in a hole in the second angular state.

In this aspect, the stabilizer may be one or more stakes configured for insertion in ground about the post, and the positioning system may include a positioning window for adjusting the positioning system between the first angular state and the second angular state.

A positioning device may be inserted through the positioning window in this aspect for adjusting the positioning device between the first angular state and the second angular state.

Further in this aspect, the positioning system may be elevated and spaced away from the post in the first angular state relative to the second angular state. The positioning system may include at least two positioning systems.

Also in this aspect, the collar may have a removal aperture, which is configured to remove the collar from about the post in a direction measured radially.

According to another aspect of the disclosure, a method of using a post positioning device may include providing a collar defining a post positioning aperture therein; receiving a post through the post positioning aperture; securing the collar about the post with a stabilizer; and adjusting a positioning system about the collar from a first angular state to a second angular state relative to the collar to maintain the post plumb in a hole in the second angular state, the positioning system being elevated and spaced away from the post in the first angular state relative to the second angular state.

In this aspect, the stabilizer may be one or more stakes and further include inserting the stakes in ground about the post. Similarly, the positioning system may be one or more systems, and this aspect may further include urging the systems against the post.

Evident from the foregoing introduction, the component parts of the post positioning jig assembly are simple and economical to manufacture and use. Other advantages of the disclosure will be apparent from the following description and the attached drawings or can be learned from practice of the disclosure.

### BRIEF DESCRIPTION OF THE SEVERAL VIEWS OF THE DRAWINGS

Having thus described the disclosure in general terms, reference will now be made to the accompanying drawings, which are not necessarily drawn to scale and are meant to be illustrative and not limiting, and wherein:

FIG. 1 is a perspective view of a post positioning jig assembly according to one embodiment of the disclosure;

FIG. 2 is a plan view of the post positioning jig assembly as in FIG. 1, particularly showing a post being adjusted and supported by positioning devices;

FIG. 3 is an elevational view of the post positioning jig assembly as in FIG. 2;

FIG. 4 is perspective view of a post positioning jig assembly according to another embodiment of the disclosure;

FIG. 5 is an exploded view of another embodiment of a post positioning jig assembly according to another aspect of the disclosure;

FIG. 6 is a partial cross-sectional, elevational view of the post positioning jig assembly as in FIG. 5; and

FIG. 7 is a view similar to FIG. 6, particularly showing final adjustments of the post positioning jig assembly about the post.

### DETAILED DESCRIPTION OF THE DISCLOSURE

The present disclosure now will be described more fully hereinafter with reference to the accompanying drawings, in which some, but not all possible embodiments are shown. Indeed, the disclosure may be embodied in many different forms and should not be construed as limited to the embodiments set forth herein; rather, these embodiments are provided so that this disclosure will satisfy applicable legal requirements.

The detailed description uses numerical and letter designations to refer to features of the drawings. Like or similar designations of the drawings and description have been used to refer to like or similar parts of various embodiments according the disclosure.

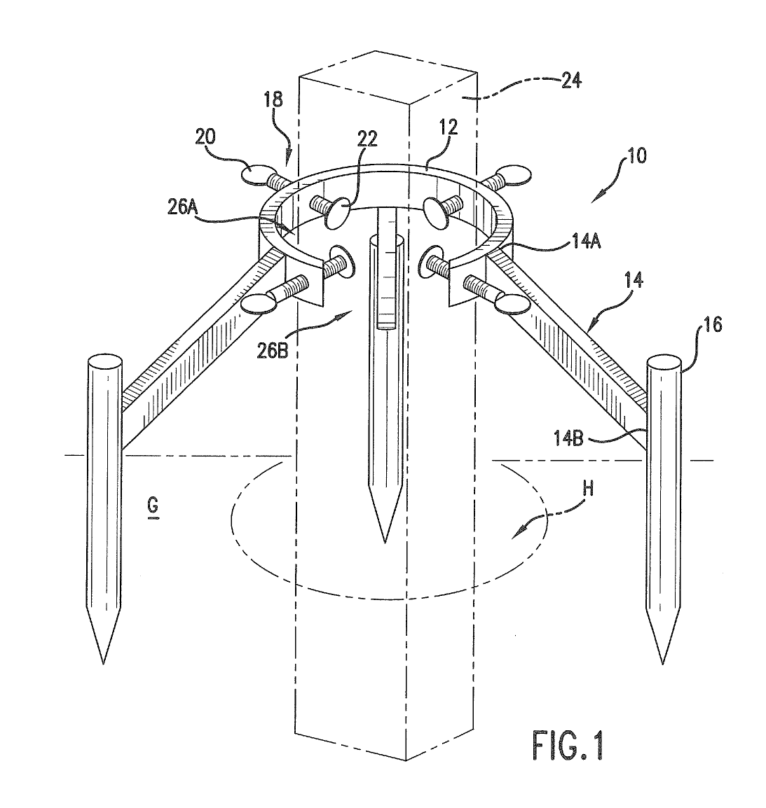

FIGS. 1, 2, and 3 broadly show a post positioning jig assembly designated in general by the reference numeral 10 in accordance with one embodiment of the present disclosure. The post positioning jig assembly 10 generally includes a positioning collar 12, one or more legs or supports 14 each having a proximal end 14A and a distal end 14B, one or more stakes or stabilizers 16, and one or more adjustable positioning members 18, such as screws, slides, ratchet devices and the like. As shown, the collar 12 may be elevated above ground by the supports 14, which are spaced sufficiently to permit concrete or other fillers to be poured into an underlying hole. As used herein, the term “collar” may mean a holder or band that is circular or square in shape or otherwise shaped complementary to particularly shaped poles. Moreover, the collar may be adjustable to increase or decrease its circumference or inner area and so is not meant as being limited to a fixed, circular device.

With particular reference to FIG. 1, the positioning collar 12 includes one or more apertures such as an aperture 26A and/or an aperture 26B defined in a perimeter of the positioning collar 12. As will be described in greater detail below, a post 24 may be inserted through either aperture 26A, 26B after the post positioning jig assembly 10 has been positioned about a posthole H. Alternatively, if due to a height of the pre-positioned post 24, the post positioning jig assembly 10 cannot be placed over a top of the post 24, the post positioning jig assembly 10 may be placed about the post 24 through the aperture 26B. Once the post positioning jig assembly 10 is disposed about the post 24 within the hole H, the stabilizers 16 can be anchored into or driven into the ground G.

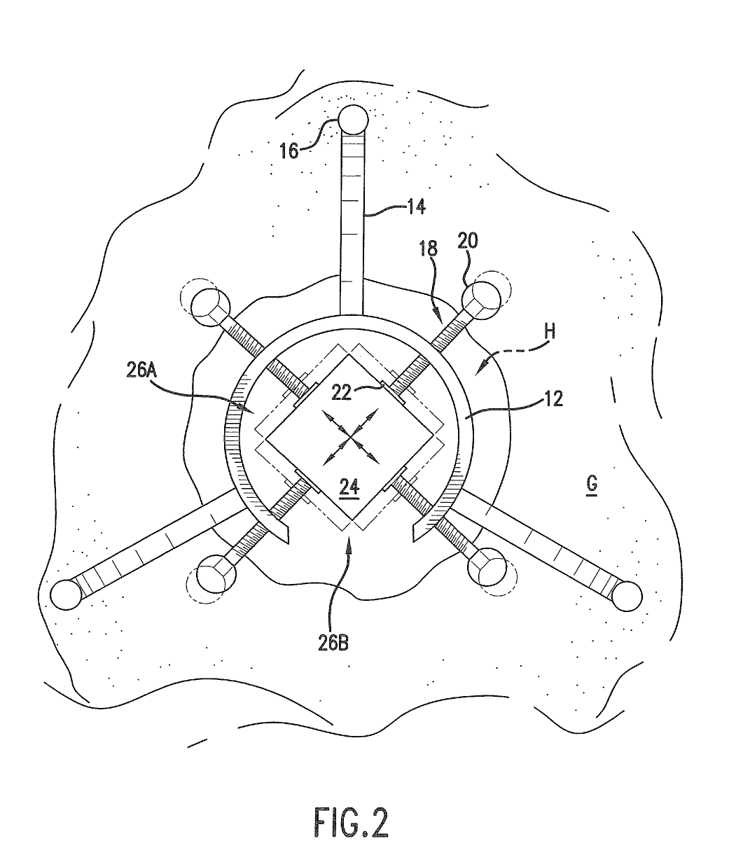

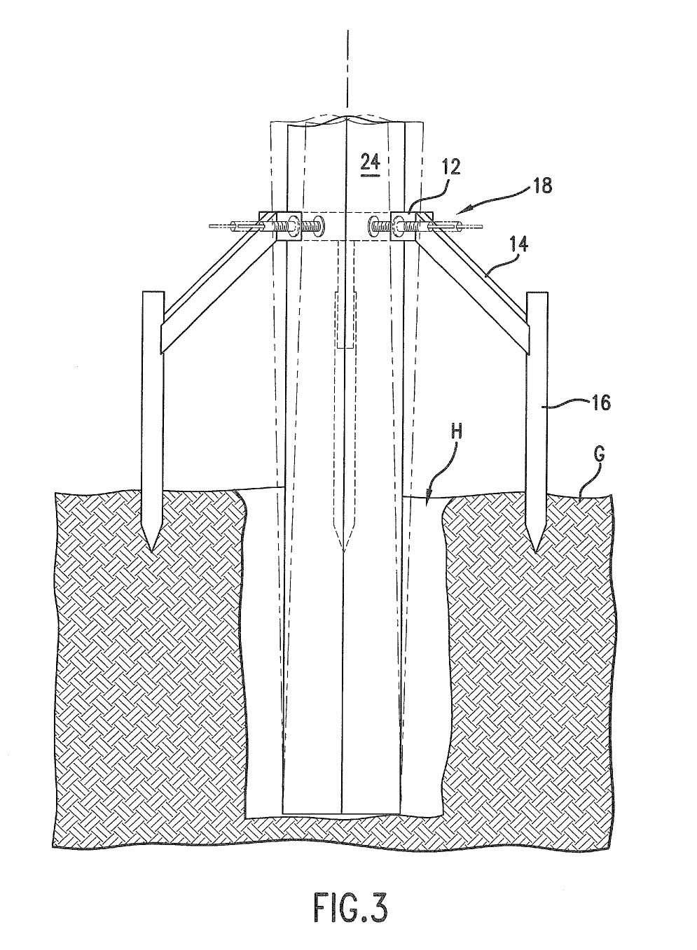

Turning now to FIGS. 2 and 3, the positioning members 18 may be used to plumb the post 24 after an end of the post 24 is in the ground G. As shown, tabs or keys 20 of the positioning members 18 may be turned to press respective holders or positioning plates 22 against respective sides of the post 24. As shown, double-headed arrows are superimposed on the post 24 to indicate various adjustments that may be made to the post 24 by the positioning members 18 in order to plumb the post 24. FIG. 3 most clearly shows the positioning members 18 being used to plumb the post 24 from an out-of-level orientation (shown in phantom) to a plumb position (shown in solid lines).

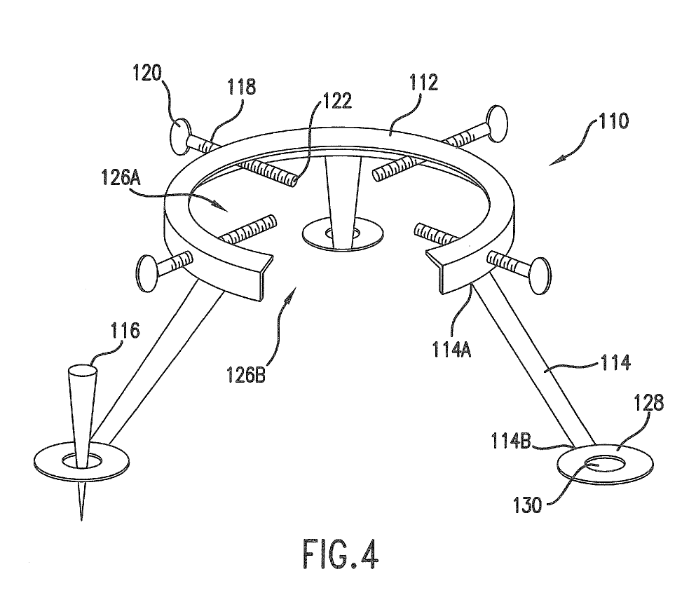

With reference to FIG. 4, a post positioning jig assembly in accordance with another embodiment of the present disclosure is designated in general by the reference numeral 110. The post positioning jig assembly 110 broadly includes a positioning collar 112, one or more support legs 114 each having a proximal end 114A and a distal end 114B, and one or more adjustable positioning members 122, such as screws, ratchets and the like, which are inserted through the positioning collar 112. Many of the components of the embodiment shown in FIG. 4 are the same as or substantially similar to those of the previously described embodiment and reference is made thereto for a full, enabling disclosure of any such components not expressly described below.

As shown in FIG. 4, each of the support legs 114 includes a support foot 128. Each support foot 128 has an opening 130 to receive respective stabilizing stakes 116. The stakes 116 are inserted through respective openings 130 once the post positioning jig assembly 110 is in a desired position about a post (not shown) and ready to be fixed in position thereabout.

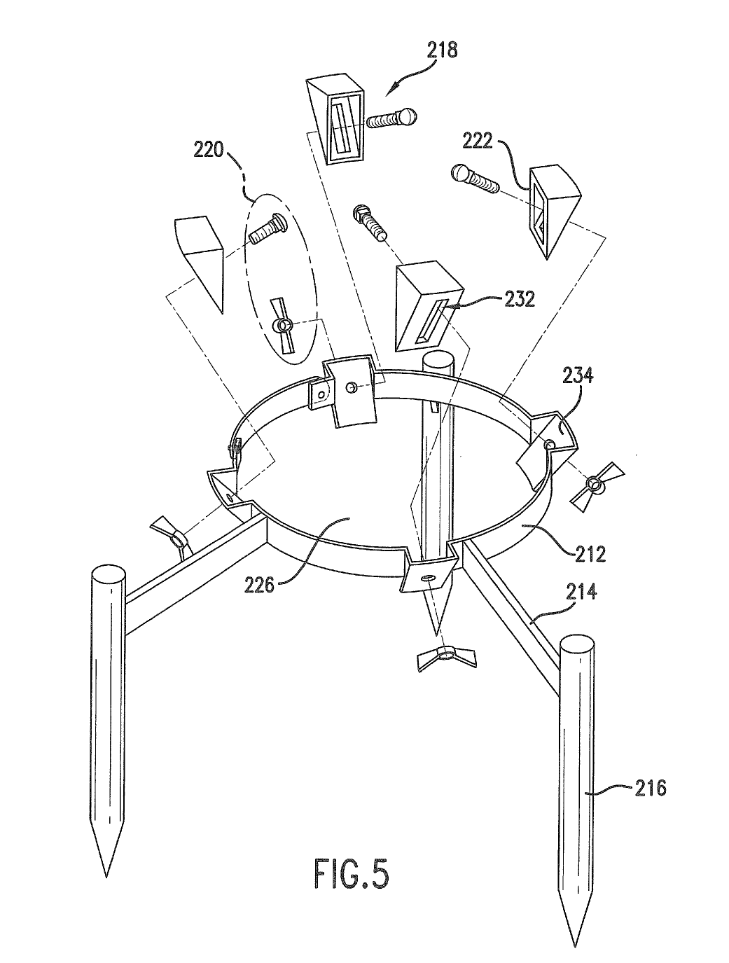

FIGS. 5-7 show another embodiment of a post positioning jig assembly, designated 210, according to another aspect of the disclosure. Many elements and components of the present embodiment are similar in respects to the previously described embodiments; thus, reference is made to the foregoing embodiments for a full, enabling disclosure of any components not expressly described below.

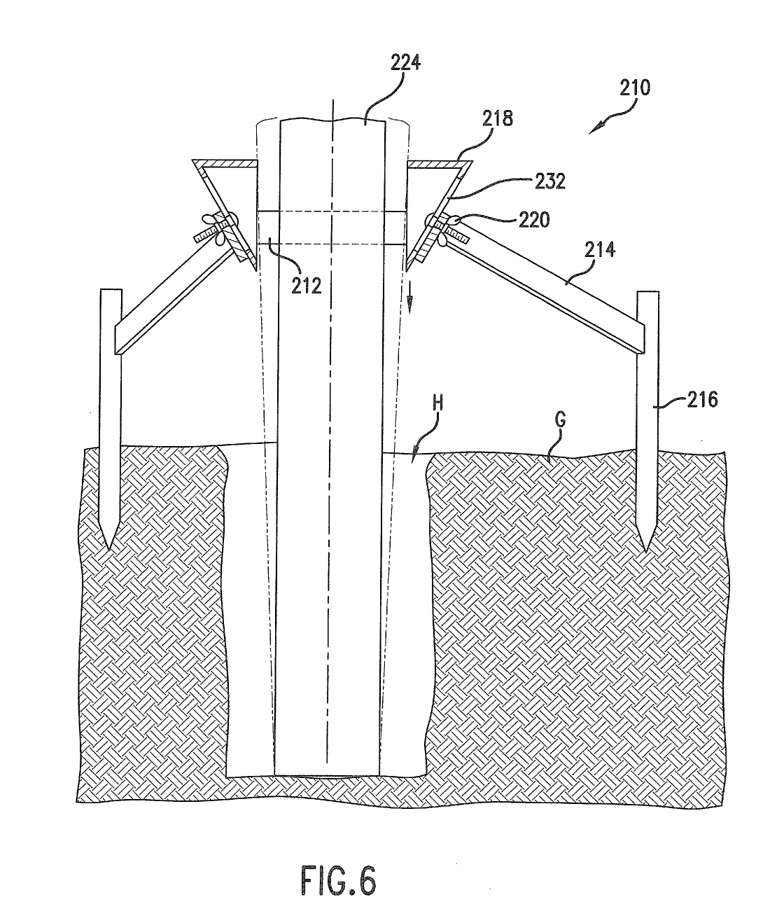

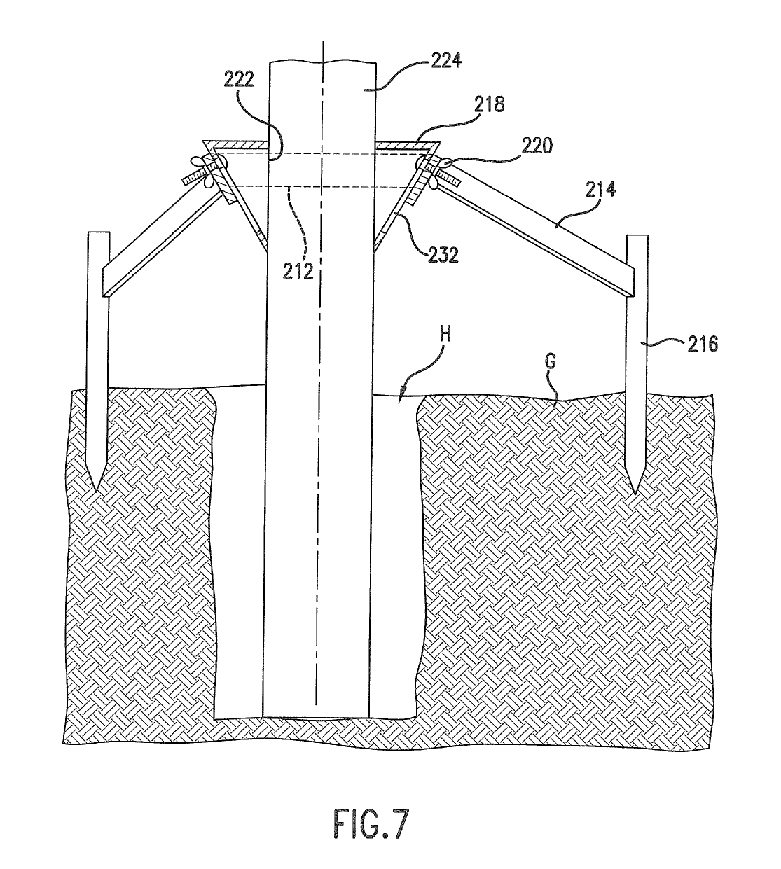

FIG. 5 particularly shows one or more positioning systems 218, each of which include an adjustment device 220, an angled adjustment face 222 and an adjustment aperture or window 232. As shown, each positioning system 218 is configured to adjustably slide on a complementary face 234 of the collar 212 such that each of the angled adjustment faces 222 slide into contact with a portion of a post 224 as will be described in operation below with respect to FIGS. 6 and 7.

Turning to FIG. 6, the post 224 is shown initially positioned in a hole H formed in the ground G, and the post positioning jig assembly 210 is shown in an initial position about the post 224. As shown, the positioning systems 218 are in a preliminary—somewhat elevated—position or first angular state relative to the support legs 214. Also, the positioning devices 220 are relatively loose to permit the face 222 of the positioning system 218 to slide up and down relative to the angled complementary face 234. Loosening the devices 220 allows the face 222 to drop and readily contact a side of the post 224 in a second angular state as indicated by the bold downward facing arrow. Specifically, when the positioning devices 220 are loosened or released, each positioning system 218 slides relative to their respective positioning devices 220 via their respective windows 232.

FIG. 7 particularly shows the positioning system 218 in final position against and about the post 224; e.g., the second angular state introduced above. Specifically, each face 222 has slid into the final position against the post 224 by virtue of each of the windows 232 permitting each of the positioning systems 218 to slide along respective positioning devices 220. The positioning devices 220 may be tapped with a hammer or mallet to further tighten the positioning devices 220 against the post 224. Once the post 224 is plumb as shown, the adjustment devices 220 may be tightened to maintain the post 224 plumb. After concrete has been poured into the hole H and cured, for instance, the foregoing steps may be reversed and the post positioning jig assembly 210 may be removed from about the post 224 and reused.

The various devices as disclosed above and their equivalents may be manufactured to permit one device to be stacked upon another, which permits transport of multiple devices in a limited amount of space. This is beneficial to contractors, for instance, who need to use several devices simultaneously to set multiple posts.

It will be apparent to those skilled in the industry that any of the foregoing embodiments and their equivalents may be employed by one person; thus, saving time, labor and costs. Moreover, while preferred embodiments of the disclosure have been shown and described, those skilled in the art will recognize that other changes and modifications may be made to the foregoing examples without departing from the scope and spirit of the disclosure. It is intended to claim all such changes and modifications as fall within the scope of the appended claims and their equivalents.

That which is claimed is:

1. A post positioning device, comprising:
a collar defining a post positioning aperture therein for receiving a post;
a stabilizer for removably securing the collar about the post;
a positioning system operably connected to the collar having a first angular state and a second angular state relative to the collar; and
wherein the positioning system is configured to adjust from the first angular state into contact with the post to maintain the post plumb in a hole in the second angular state.

2. The post positioning device as in claim 1, wherein the stabilizer is a plurality of stakes being configured for insertion in ground about the post.

3. The post positioning device as in claim 1, wherein the positioning system includes a positioning window therein for adjusting the positioning system between the first angular state and the second angular state.

4. The post positioning device as in claim 3, wherein the positioning system includes a positioning device disposed through the positioning window for adjusting the positioning device between the first angular state and the second angular state.

5. The post positioning device as in claim 1, wherein the positioning system is elevated and spaced away from the post in the first angular state relative to the second angular state.

6. The post positioning device as in claim 1, wherein the positioning system is at least two positioning systems.

7. The post positioning device as in claim 1, wherein the collar defines a removal aperture therethrough, the removal aperture being configured to remove the collar from about the post in a direction measured radially.

8. A method of using a post positioning device, comprising:
providing a collar defining a post positioning aperture therein;
receiving a post through the post positioning aperture;
securing the collar about the post with a stabilizer; and
adjusting a positioning system about the collar from a first angular state to a second angular state relative to the collar to maintain the post plumb in a hole in the second angular state, the positioning system being elevated and spaced away from the post in the first angular state relative to the second angular state.

9. The method as in claim 8, wherein the stabilizer is a plurality of stakes and further comprising inserting the stakes in ground about the post.

10. The method as in claim 8, wherein the positioning system is a plurality of systems and further comprising urging the systems against the post.
